(19) United States
(12) Patent Application Publication
(10) Pub. No.: US 2025/0061052 A1
(43) Pub. Date: Feb. 20, 2025

(54) SYSTEM AND METHOD FOR MANAGING TEST CASE OF A TEST FOR TESTING VEHICLE SYSTEM

(71) Applicant: Woven by Toyota, Inc., Tokyo (JP)

(72) Inventors: Beck CHEN, Tokyo (JP); Benjamin Ioller, Tokyo (JP); Jilada Eccleston, Tokyo (JP); Antonio Tienda Fernandez, Tokyo (JP); James Cumming, Tokyo (JP); Cyril Courtoy, Tokyo (JP); Haitham Ahmed, Tokyo (JP)

(73) Assignee: Woven by Toyota, Inc., Tokyo (JP)

(21) Appl. No.: 18/234,452

(22) Filed: Aug. 16, 2023

(51) Int. Cl. G06F 11/36

(52) U.S. Cl. CPC G06F 11/3664; G06F 11/3684; G06F 11/3688

(57) ABSTRACT

Provided are a system, method, and device for managing one or more test cases of a test for testing a software of a vehicle system. According to embodiments, the method may be implemented by at least one processor and may include: presenting, to a user, a first graphical user interface (GUI) comprises information of one or more test cases available to the user; receiving, from the user, a user input defining a user selection of a test case from among the one or more available test cases; and performing at least one operation for managing the user-selected test case.

### TECHNICAL FIELD

Systems and methods consistent with example embodiments of the present disclosure relate to test case management, and more particularly, relate to managing one or more test cases of a test for testing a software associated with a vehicle system.

### BACKGROUND

A testing for software is required in order to ensure that the software functions as intended, meets the specified requirements, and performs reliably in various scenarios. Software testing is a crucial part of the software development life cycle (SDLC) and is performed to identify defects, errors, or bugs in the software before it is deployed to the actual system.

In order to develop advanced or complex features in a system, testing of functionality and performance of multiple software components and/or hardware components across multiple systems or domains may be required. In the context of vehicle systems, a cross-domain test may be required during development of advanced features in a vehicle system, such as Lane Change Assist, Mobile Smart Keys, and the like, and the cross-domain test may involve testing the interaction between different electronic control units (ECUs) and the associated software and hardware components across different systems. For instance, different testing systems may be utilized for providing testing at different fidelity levels (e.g., virtual ECU, emulated ECU, simulated ECU, etc.), for providing testing at different vehicle variants or platforms, and/or for providing testing for software developed by different developers.

In order to appropriately perform a test for testing a software of a vehicle system, different testing conditions defined by multiple test cases may be required. In this regard, a test case may refer to a specific set of conditions or test steps that are utilized during the test to verify the functionality or behavior of the software. A test case may include, amongst other, a detailed description of the test step(s) to be performed during the testing. Thus, when testing a software with complex feature, particularly when the testing involves cross-systems or cross-domains requirements, the management of the test cases of the test (such as organizing, creating, documenting, and/or tracking status of test cases) throughout the SDLC may be complicated and challenging.

To begin with, in the related art, test cases available to the user(s) may be limited or restricted by those embedded with the available testing system(s). Namely, whenever the user(s) utilizes a specific test system for testing the software, the user(s) may only able to utilize the test cases provided by the specific test system. The user(s) may not be able to easily configure, adjust, specify, or the like, test cases provided by the testing system(s) according to the intended testing requirements. The situation becomes even complicated and challenging when the test involves multiple testing systems, while a test case built for a portion of the testing systems is not compatible or executable on another portion of the testing systems. Thus, in the related art, the user(s) tends to utilize only the available or provided test cases and to avoid modification on the test cases as much as possible.

Further, whenever the utilization of a specific test case is unavoidable, the user(s) may need to spend significant effort, time, and cost to build the intended test case. Furthermore, since different test systems may have different test case requirements and may not be compatible to each other, whenever the user want to utilize the specific test case at different fidelity levels and/or for different vehicle variants, the user may need to repeat the process, which may in turn significantly increases the effort, time, and cost for building the specific test case. Particularly, for a user who does not have experience in building a test case and/or does not have any technical background, the process for building a specific test case may be even more burdensome and costly.

In addition, in the related art, there is no way for a user to efficiently and easily share a test case with another user(s). Thus, even if the a user would like to utilize a specific test case which may have been built by other user in the past, there is no way for the user to do so.

Furthermore, in the related art, the processes of searching for available test cases, creating a new test case, and deploying the newly built test case to the existing test system(s) are performed separately on different, independent systems. Thus, the management of the test cases are inefficient and ineffective.

In view of the above, the limitations and restrictions in managing the test cases in the related art's systems may cause wastage of resources (e.g., man power, time, cost, etc.) and may result in delay of the testing. Accordingly, the testing of a software in the related art may be time consuming and inefficient, and the development of the software may be delayed.

### SUMMARY

According to embodiments, a method for managing one or more test cases of a test for testing a software associated with a vehicle system may be provided. The method may be implemented by at least one processor of a system and may include: presenting, to a user, a first graphical user interface (GUI) comprises information of one or more test cases available to the user; receiving, from the user, a user input defining a user selection of a test case from among the one or more available test cases; and performing at least one operation for managing the user-selected test case.

According to embodiments, the presenting the first GUI may include: obtaining, from at least one storage medium, information associated with the user; determining, based on the obtained user information, the one or more available test cases; generating the first GUI to include information associated with the one or more available test cases; and transmitting the first GUI to a user equipment associated with the user. The obtained user information may include at least one of: a role of the user, a project associated with the user, a workgroup associated with the user, and a location associated with the user.

According to embodiments, the first GUI may include one or more interactive elements each of which is associated with an available test case from among the one or more available test case. Further, the receiving the user input may include: receiving a user interaction with at least one interactive element from among the one or more interactive elements; and determining the available test case associated with the user-interacted at least one interactive element as the user-selected test case.

According to embodiments, the performing the at least one operation may include: presenting, to the user, a second GUI comprises information associated with the user-selected test case; receiving, from the user, a user input for modifying at least a portion of the information associated with the user-selected test case; and generating, based on the user input, a new test case, wherein the new test case comprises at least a portion of information different from the user-selected test case.

According to embodiments, the information associated with the user-selected test case may include: at least one test step associated with the user-selected test case. The second GUI may include at least one input field associated with the at least one test step. The receiving the user input may include: receiving a user selection on at least one parameter for defining the at least one test step. The generating the new test case may include: generating the new test case based on the user-defined at least one test step.

According to embodiments, the receiving the user selection on the at least one parameter may include: receiving, from the user, one or more user inputs in the at least one input field, wherein the one or more user inputs may include one or more keywords associated with the at least one parameter. The at least one parameter may include at least one of: a parameter defining a software-based ECU, a parameter defining a hardware-based ECU, and a parameter defining test environment fidelity.

According to embodiments, the at least one input field may include a pre-filled parameter, and the receiving the user selection on the at least one parameter may include: receiving, from the user, an approval on the pre-filled parameter or a modification on the pre-filled parameter. Additionally or alternatively, the at least one input field may include a plurality of selectable parameters, and the receiving the user selection on the at least one parameter may include: receiving, from the user, at least one user selection on at least one parameter from among the plurality of selectable parameters.

According to embodiments, a system for managing one or more test cases of a test for testing a software associated with a vehicle system may be provided. The system may include: at least one memory storage storing instructions; and at least one processor configured to execute the instructions to: present, to a user, a first graphical user interface (GUI) comprises information of one or more test cases available to the user; receive, from the user, a user input defining a user selection of a test case from among the one or more available test cases; and perform at least one operation for managing the user-selected test case.

According to embodiments, the at least one processor may be configured to execute the instructions to present the first GUI by: obtaining, from at least one storage medium, information associated with the user; determining, based on the obtained user information, the one or more available test cases; generating the first GUI to include information associated with the one or more available test cases; and transmitting the first GUI to a user equipment associated with the user. The obtained user information may include at least one of: a role of the user, a project associated with the user, a workgroup associated with the user, and a location associated with the user.

According to embodiments, the first GUI may include one or more interactive elements each of which is associated with an available test case from among the one or more available test case, and wherein the at least one processor may be configured to execute the instructions to receive the user input by: receiving a user interaction with at least one interactive element from among the one or more interactive elements; and determining the available test case associated with the user-interacted at least one interactive element as the user-selected test case.

According to embodiments, the at least one processor may be configured to execute the instructions to perform the at least one operation by: presenting, to the user, a second GUI comprises information associated with the user-selected test case; receiving, from the user, a user input for modifying at least a portion of the information associated with the user-selected test case; and generating, based on the user input, a new test case, wherein the new test case may include at least a portion of information different from the user-selected test case. The at least one parameter may include at least one of: a parameter defining a software-based ECU, a parameter defining a hardware-based ECU, and a parameter defining test environment fidelity.

According to embodiments, the information associated with the user-selected test case may include: at least one test step associated with the user-selected test case. The second GUI may include at least one input field associated with the at least one test step. The at least one processor may be configured to execute the instructions to receive the user input by: receiving a user selection on at least one parameter for defining the at least one test step. The at least one processor may be configured to execute the instructions to generate the new test case by: generating the new test case based on the user-defined at least one test step.

According to embodiments, the at least one processor may be configured to execute the instructions to receive the user selection on the at least one parameter by: receiving, from the user, one or more user inputs in the at least one input field. The one or more user inputs may include one or more keywords associated with the at least one parameter.

According to embodiments, the at least one input field may include a pre-filled parameter, and the at least one processor may be configured to execute the instructions to receive the user selection on the at least one parameter by: receiving, from the user, an approval on the pre-filled parameter or a modification on the pre-filled parameter. Alternatively or additionally, the at least one input field may include a plurality of selectable parameters, and the at least one processor may be configured to execute the instructions to receive the user selection on the at least one parameter by: receiving, from the user, at least one user selection on at least one parameter from among the plurality of selectable parameters.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example system architecture for managing one or more test cases of a test for testing one or more software associated with a vehicle system, according to one or more embodiments;

FIG. 2 illustrates a block diagram of example components of a test case management system, according to one or more embodiments;

FIG. 3 illustrates an example graphical user interface (GUI) presented by the test case management system, according to one or more embodiments;

FIG. 4 illustrates another example GUI presented by the test case management system, according to one or more embodiments;

FIG. 5 illustrates yet another example GUI presented by the test case management system, according to one or more embodiments;

FIG. 6 illustrates yet another example GUI presented by the test case management system, according to one or more embodiments; and

FIG. 7 illustrates a flow diagram of an example method for managing one or more test cases of a test for testing a software associated with a vehicle system, according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In addition, the term “vehicle” or the like, as used herein, may refer to any motorized and/or mechanical machine which may carry or transport people and/or cargo, such as: a car, a truck, a motorcycle, a bus, a bicycle, a mobility scooter, and the like.

The terms “test artifacts”, “testing artifacts”, and the like, described herein may refer to one or more components constitute a test. For instance, the test artifacts may include one or more software-based components (e.g., virtual ECU, emulated ECU, vehicle model, etc.), one or more hardware-based components (e.g., physical ECU, vehicle hardware component, etc.), one or more test configuration (e.g., test environment configuration, test cycle, test execution, etc.), one or more test scenarios, one or more test cases, one or more test packages, and/or the like.

Example embodiments consistent with the present disclosure provide methods, systems, and apparatuses for managing one or more test cases of a test for testing one or more software of a vehicle system, such as one or more in-vehicle ECUs. According to embodiments, methods, systems, apparatuses, or the like, of the present disclosure may enable one or more users to effectively and efficiently manage one or more test cases of a test for testing a software of a vehicle system.

In some implementations, methods, systems, apparatuses, or the like, of the present disclosure may generate and present at least one graphical user interface (GUI) to the one or more users, such that the one or more users may utilize the at least one GUI to view and search for available test case(s), to manage test case(s) associated with themselves, to share one or more test cases, and to create one or more new test cases. According to embodiments, a user may utilize the at least one GUI to select an available test case and to utilize the selected test case as a template in creating one or more new test cases.

The at least one GUI may be generated based on user information (e.g., a role of the user, etc.), such that the at least one GUI may contains information and components suitable for the users. In this way, example embodiments of the present disclosure allows users with different background to efficiently and effectively manage one or more test cases in their intended manner.

Ultimately, example embodiments of the present disclosure enable one or more test cases to be timely and consistently synchronized. Accordingly, the testing of a software may be performed and managed more efficiently, the burden of the users may be significantly reduced, and the time and cost required for developing the software may be significantly reduced.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

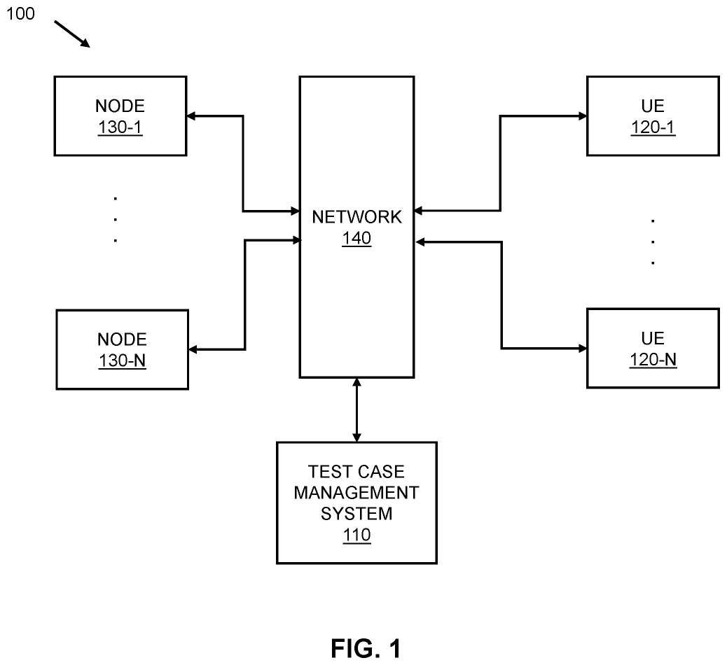

FIG. 1 illustrates a block diagram of an example system architecture 100 for managing one or more test cases of a test for testing one or more software associated with a vehicle system, according to one or more embodiments. According to embodiments, the software may include one or more software-based (e.g., virtualized, emulated, etc.) in-vehicle electronic control units (ECUs). As illustrated in FIG. 1, system architecture 100 may include a test case management system 110, a plurality of user equipment (UE) 120-1 to 120-N, a plurality of nodes 130-1 to 130-N, and a network 140.

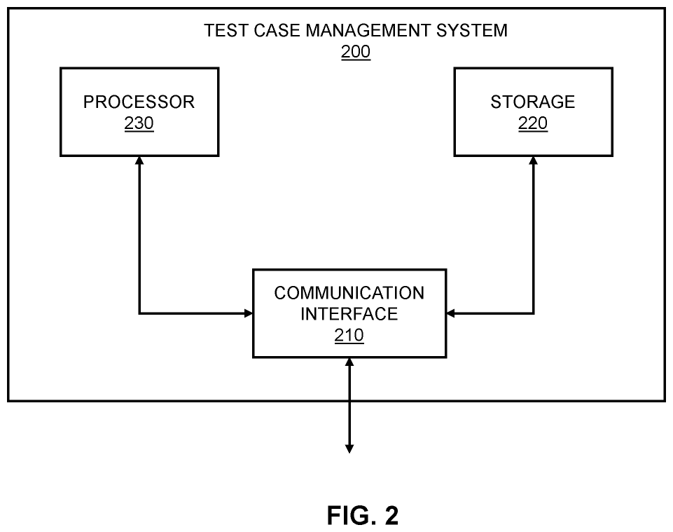

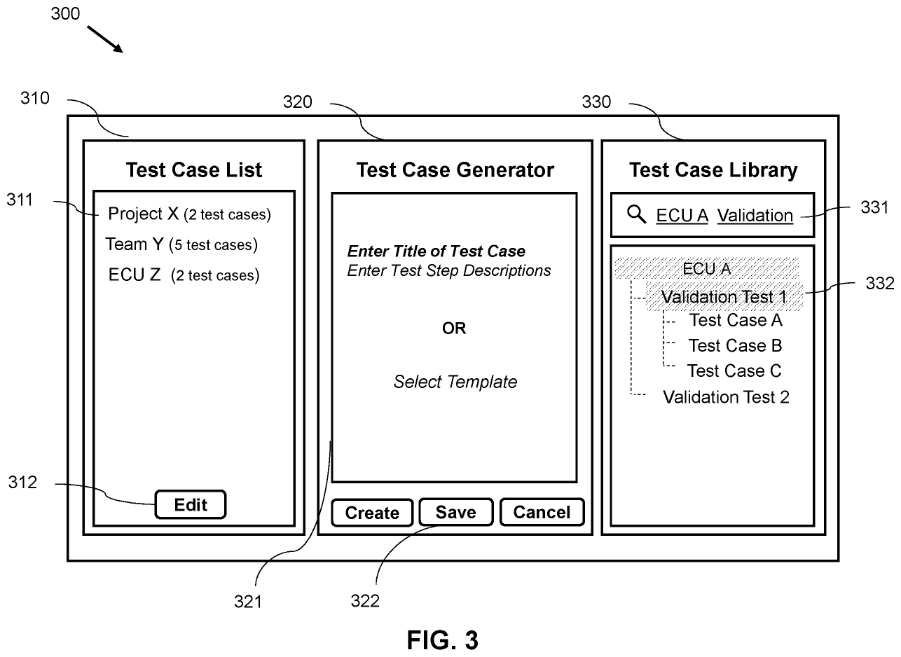

In general, the test case management system 110 may be communicatively coupled to the plurality of UEs 120-1 to 120-N and the plurality of nodes 130-1 to 130-N via the network 140, and may be configured to interoperate with the plurality of UEs 120-1 to 120-N and the plurality of nodes 130-1 to 130-N to manage one or more test cases for one or more associated users. Descriptions of example components which may be included in the test case management system 110 are provided below with reference to FIG. 2, and descriptions of the associated operations and use cases are provided below with reference to FIG. 3 to FIG. 7.

Each of the plurality of UEs 120-1 to 120-N may include one or more machines, devices, or the like, which is capable of receiving, generating, storing, processing, and/or providing information upon being utilized by the associated user. For example, one or more of the plurality of UEs 120-1 to 120-N may include a computing device (e.g., a desktop computer, a laptop computer, a tablet computer, a handheld computer, a smart speaker, a server, etc.), a mobile device (e.g., a smart phone, etc.), a wearable device (e.g., a pair of smart glasses or a smart watch), a SIM-based device, or any other suitable device which may be associated with one or more users involve in the testing of the software.

The plurality of UEs 120-1 to 120-N may be utilized by one or more associated users to access and to utilize the test case management system 110. For instance, the user(s) may access, via the associated UE, the test case management system 110 to manage one or more test cases. For instance, the user(s) may utilize, via the associated UE, the test case management system 110 to search for one or more available test cases, to build one or more test cases, to view one or more associated test cases, to modify one or more test cases, to share one or more test cases, and the like. Further, the user(s) may also utilize the test case management system 110 to obtain (e.g., view, download, etc.) information associated with the one or more test cases (e.g., content of the test cases, creator of the test cases, test artifacts associated with test cases, etc.).

According to embodiments, at least a portion of the plurality of UEs 120-1 to 120-N may be located at different geographical locations. For instance, a first portion of the plurality of UEs 120-1 to 120-N may be utilized by a first user (e.g., a developer of a first ECU, etc.) and the first user may locate at a first location, while a second portion of the plurality of UEs 120-1 to 120-N may be utilized by a second user (e.g., a developer of a second ECU, etc.) and the second user may locate at a second location different from the first location.

On the other hand, each of the plurality of nodes 130-1 to 130-N may include one or more devices, equipment, systems, or any other suitable components which may receive, host, store, deploy, process, provide, or the like, information and data associated with the testing. According to embodiments, at least a portion of the plurality of nodes 130-1 to 130-N may be configured to host, deploy, store, provide, or the like, one or more test artifacts or components which are associated with one or more test cases.

For instance, the portion of the plurality of nodes 130-1 to 130-N may include a device or an equipment which may be utilized for building, storing, executing, simulating, executing, or the like, one or more computer executable software applications, such as one or more virtualized ECUs, one or more emulated ECUs, and/or any other suitable software-based components (e.g., vehicle model, Data Communications Module (DCM) model, Heating, Ventilation, and Air Conditioning (HVAC) model, etc.), of a vehicle system. As another example, the portion of the plurality of nodes 130-1 to 130-N may include or may be communicatively coupled to one or more hardware-based components, such as one or more fully developed physical ECUs, one or more partially developed physical ECUs, one or more vehicle hardware components (e.g., powertrain, engine, etc.), or the like. One or more of the aforesaid software-based components and the hardware-based components may be associated with the one or more test cases being management by the test case management system 110. For instance, said one or more test cases may include information (e.g., step(s), condition(s), etc.) for utilizing or testing said one or more of the aforesaid software-based components and the hardware-based components.

According to embodiments, one or more of the plurality of nodes 130-1 to 130-N may include one or more interfaces, each of which may be configured to communicatively coupled the associated node to the test case management system 110. For instance, the one or more of the plurality of nodes may include a hardware interface, a software interface (e.g., a programmatic interface, application program interface (API), etc.), and/or the like.

According to embodiments, at least a portion of the plurality of nodes 130-1 to 130-N may be located at a geographical location different from the test case management system 110, different from one or more of the plurality of UEs 120-1 to 120-N, and/or different from another portion of the plurality of nodes 130-1 to 130-N.

According to embodiments, at least a portion of the plurality of nodes 130-1 to 130-N may be associated with one or more test environments. For instance, said portion of nodes may have at least one software-based test environment (e.g., software-in-the-loop (SIL) test environment, virtual ECU (V-ECU) test environment, model-in-the-loop (MIL) test environment, processor-in-the-loop (PIL) test environment, etc.) and/or at least one hardware-based test environment (e.g., hardware-in-the-loop (HIL) test environment) communicatively coupled thereto (e.g., wired coupling, wireless coupling, etc.) or deployed thereto. In this regard, the portion of the plurality of nodes 130-1 to 130-N may receive one or more test cases (e.g., test case built by the user, test case associated with the user, etc.) from the test case management system 110, and may be configured to utilize the received test case(s) to automatically perform a testing on the desired software and/or hardware components based thereon.

Further, at least a portion of the plurality of nodes 130-1 to 130-N may include one or more storage mediums, such as a server or a server cluster, which may be configured to store, publish, or the like, one or more data or information provided by the test case management system 110, one or more of the plurality of UEs 120-1 to 120-N, and/or another portion of the plurality of nodes 130-1 to 130-N.

The network 140 may include one or more wired and/or wireless networks, which may be configured to couple the test case management system 110, the plurality of UEs 120-1 to 120-N, and the plurality of nodes 130-1 to 130-N, to one another. For example, the network 140 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

According to embodiments, the network 140 may include a virtual network, which may include one or more physical network components (e.g., Ethernet, WiFi module, telecommunication network hardware, etc.) with one or more virtualized network functions (e.g., a control area network (CAN) bus, etc.) implemented therein.

Referring next to FIG. 2, which illustrates a block diagram of example components of a test case management system 200, according to one or more embodiments. The test case management system 200 may be similar to test case management system 110 in FIG. 1.

As illustrated in FIG. 2, the test case management system 200 may include at least one communication interface 210, at least one storage 220, and at least one processor 230, although it can be understood that the test case management system 200 may include more or less components than as illustrated, and/or the components included therein may be arranged in any manner different from as illustrated, without departing from the scope of the present disclosure.

The communication interface 210 may include a transceiver-like component (e.g., a transceiver, a separate receiver and transmitter, etc.) that enables the test case management system 200 (or one or more components included therein) to communicate with one or more components external to the test case management system 200, such as via a wired connection, a wireless connection, or a combination of wired and wireless connections. For instance, the communication interface 210 may couple the test case management system 200 (or one or more components included therein) to a plurality of UEs (e.g., UE 120-1 to 120-N in FIG. 1, etc.) and to a plurality of nodes (e.g., nodes 130-1 to 130-N in FIG. 1, etc.) to thereby enable them to communicate and to interoperate with each. As another example, the communication interface 210 may enable the components of the test case management system 200 to communicate with each other. For instance, the communication interface 210 may couple the storage 220 to the processor 230 to thereby enable them to communicate and to interoperate with each other.

According to embodiments, the communication interface 210 may include a hardware-based interface, such as a bus interface, an Ethernet interface, an optical interface, a coaxial interface, an infrared interface, a radio frequency (RF) interface, a universal serial bus (USB) interface, a Wi-Fi interface, a cellular network interface, a software interface, or the like. According to embodiments, communication interface 210 may include at least one controller area network (CAN) bus configurable to communicatively couple the components of the test case management system 200 (e.g., storage 220, processor 230, etc.) to a plurality of UEs (e.g., UE 120-1 to 120-N) and to a plurality of nodes (e.g., nodes 130-1 to 130-N). Additionally or alternatively, the communication interface 210 may include a software-based interface, such as an application programming interface (API), a virtualized network interface (e.g., virtualized CAN bus, etc.), or the like.

According to embodiments, the communication interface 210 may be configured to receive information from one or more components external to the test case management system 200 and to provide the same to the processor 230 for further processing and/or to the storage 220 for storing. For instance, the communication interface 210 may receive, from the plurality of UEs, one or more user inputs for managing one or more test cases (e.g., defining and building a test case(s), viewing a test case(s), arranging a test case(s), modifying a test case(s), sharing a test case, etc.), and may provide the same to the processor 230 and/or the storage 220.

Similarly, the communication interface 210 may be configured to enable the processor 230 of the test case management system 200 to provide one or more information to one or more components external to the test case management system 200. For instance, the communication interface 210 may enable the processor 230 to provide or transmit one or more GUIs to the plurality of UEs, or the like.

The at least one storage 220 may include one or more storage mediums suitable for storing data, information, and/or computer-readable/computer-executable instructions therein. According to embodiments, the storage 220 may include a random access memory (RAM), a read only memory (ROM), and/or another type of dynamic or static storage device (e.g., a flash memory, a magnetic memory, and/or an optical memory) that stores information and/or instructions for use by the processor 230.

Additionally or alternatively, the storage 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 220 may be configured to store information to-be utilized by the processor 230 for performing one or more operations to manage one or more test cases for one or more users. For instance, the storage 220 may be configured to store one or more test cases built or created by one or more users, to store information associated with one or more users, to store information of one or more test artifacts, to store information of one or more test environments, and the like.

The at least one processor 230 may be configured to receive (e.g., via the communication interface 210, etc.) one or more signals defining one or more instructions for performing one or more operations. Further, the processor 230 may be implemented in hardware, firmware, or a combination of hardware and software. The processor 230 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to embodiments, the at least one processor 230 may include one or more processors capable of being programmed to perform a function or an operation for managing one or more test cases. For instance, the processor 230 may be configured to execute computer-readable instructions stored in a memory storage (e.g., storage 220, etc.) to thereby perform one or more actions or one or more operations described herein.

By way of example, the at least one processor 230 may, upon determining an access of a user, generate and present one or more graphical user interfaces (GUIs) to the user to thereby enable the user to interact with the test case management system 200 for managing one or more test cases (e.g., viewing test case(s), searching test case(s), creating test case(s), modifying test case(s), sharing test case(s), etc.). Descriptions of example GUIs which may be generated by the processor 230 to interact with one or more users are provided in the following with reference to FIG. 3 to FIG. 6.

Referring first to FIG. 3, which illustrates an example GUI 300, according to one or more embodiments. GUI 300 may be generated by at least one processor (e.g., processor 230) of the test case management system and may be presented by the at least one processor to a user to allow the user to search and view information of test case(s) available to the user, as well as to create or define a new test case.

According to embodiments, the at least one processor may generate and present the GUI 300 when the user first accessing and/or logging in to the test case management system. For instance, upon determining an access of the user (e.g., upon receiving an access request from an UE associated with the user, upon receiving an authorization and/or an authentication from a security system, upon verifying the identity of the user, etc.), the at least one processor may obtain (from one or more storage mediums such as storage 220 and/or external server(s), etc.) information associated with the user (may be referred to as “user information” herein) and may generate the GUI 300 based thereon.

The user information may include a role or a persona of the user (e.g., test engineer, business manager, software developer, vendor user, etc.), a workgroup of the user (e.g., team to which the user belongs, team with which the user collaborating, etc.), one or more projects associated with the user (e.g., project(s) in which the user involves, previously built test case(s), etc.), a location associated with the user (e.g., current location of the user, last known location of the user, planned location of the user, etc.), and/or the like. The user information may be included in one or more user profiles associated with the user, such that upon determining the access of the user, the at least one processor may retrieve (based on credentials of the user such as user ID, etc.) the one or more user profiles from the one or more storage mediums.

Accordingly, the at least one processor may generate the GUI 300 based on the obtained user information. For instance, the at least one processor may determine (based on the obtained user information) which test case(s) is associated with the user, may collect the information of the associated test case(s) from among a plurality of nodes (e.g., nodes 130-1 to 130-N in FIG. 1, etc.), and may include such information in the GUI 300 (further described below with reference to the first portion 310 of GUI 300).

As another example, the at least one processor may determine (based on the obtained user information) whether there is any pending project (e.g., whether there is any pending test case to-be built, etc.), may determine the progress of the pending project (if any), and may include such information in the GUI 300, such that the user may resume to work on the pending project(s). Otherwise, based on determining that there is no pending project available for the user, the at least one processor may generate the GUI 300 such that the user can quickly start a project to build or create one or more desired test cases (further described below with reference to the second portion 320 of GUI 300).

As yet another example, the at least one processor may determine (based on the obtained user information) which test case(s) is available to the user, may collect the information of the available test case(s) from among the plurality of nodes (e.g., nodes 130-1 to 130-N in FIG. 1, etc.), and may include such information in the GUI 300 (further described below with reference to the third portion 330 of GUI 300).

In some implementation, the at least one processor may continuously (or periodically) obtain the latest user information and update the GUI 300 (if any), such that the GUI 300 may always include the updated information of the test cases.

Referring to FIG. 3, the GUI 300 may include a first portion 310, a second portion 320, and a third portion 330. The first portion 310 may include a list of test cases associated with the user, and the test cases may be categorized into one or more categories. For instance, in the example of FIG. 3, the first portion 310 includes a list 311 which includes test cases associated with the user, and the test cases are categorized into different categories according to project in which the test cases are involved (illustrated as “Project X” in FIG. 3), according to team or workgroup with which the test cases are associated (illustrated as “Team Y” in FIG. 3), according to function or feature with which the test cases are associated (illustrated as “ECU Z” in FIG. 3). It can be understood that the test cases associated with the user may be categorized in any other suitable manner, without departing from the scope of the present disclosure.

Each of the test cases presented in the first portion 310 may have an interactive element interactable by the user associated therewith. For instance, the descriptions of each of the test cases may be presented in the form of selectable or interactable texts which, when being interacted (e.g., clicked, etc.) by the user, enable the user to select the associated test case.

The first portion 310 may also include one or more interactive elements to allow the user to manage the list 311. For instance, in the example of FIG. 3, the first portion 310 may include a button 312 which, when being interacted by the user, enable the user to edit the list 311, such as to rename each of the categories of the test cases in the list 311, to reorganize the test cases from one category to another category, to add or remove one or more categories, and/or the like.

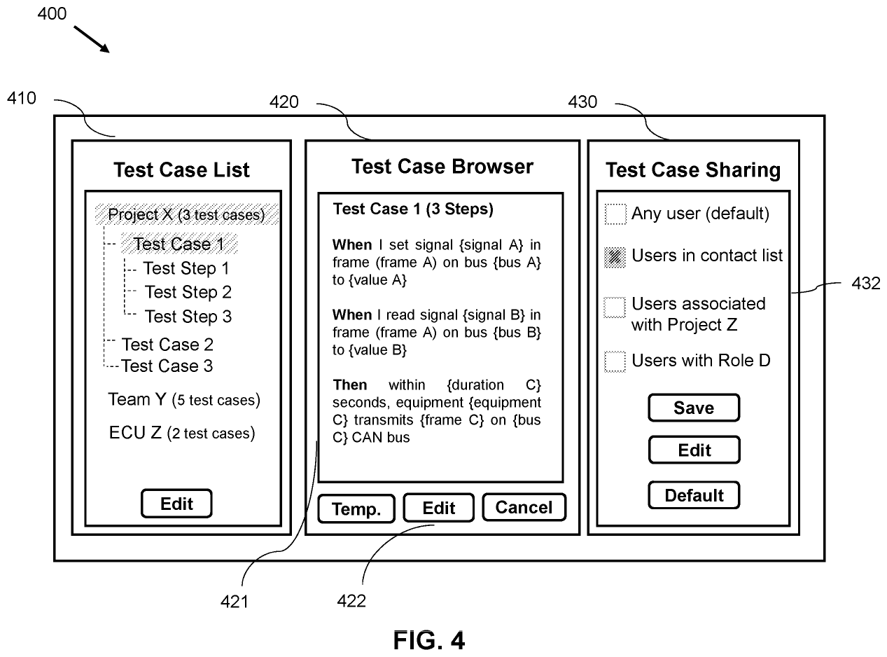

The second portion 320 may include an input window 321 and a plurality of interactive elements 322 which, when being interacted by the user, enable the user to define and create one or more new test cases. According to embodiments in which there is a pending test case(s) to-be built (e.g., the user has partially created the test case and has saved the project for further use, etc.), the second portion 320 may include the information of the pending test case(s) and the user may continue working on said pending test case(s). Furthermore, as further described below with reference to FIG. 4, in some implementations, the second portion 320 may include information of one or more test cases selected by the user (e.g., test case selected from the first portion 310 and/or the third portion 330, etc.).

The input window 321 may be configured to receive one or more user inputs from the user for specifying, defining, and creating the one or more test cases. According to embodiments, the user may simply input into the input window 321 the descriptions of the intended test step(s) for defining the intended test case(s). According to embodiments, the at least one processor may receive one or more inputs defining the intended test case(s) from the user in a first format (e.g., generic format, etc.) and may automatically convert the one or more user input(s) into a second format (e.g., a specific programming language, a specific format, etc.).

According to embodiments, concurrently with the user inputting the descriptions into the input window 321, the at least one processor may search for the test artifact(s) associated with the descriptions and may present one or more recommendations to the user in the input window 321. By way of example, based on determining that the user has inputted the terms “ECU A” and “service” into the input window 321, the at least one processor may update the input window 321 to present (in a drop-down list, etc.) information of one or more services associated with “ECU A”, such that the first user may simply select the intended “service” associated with “ECU A” from the presented recommendations.

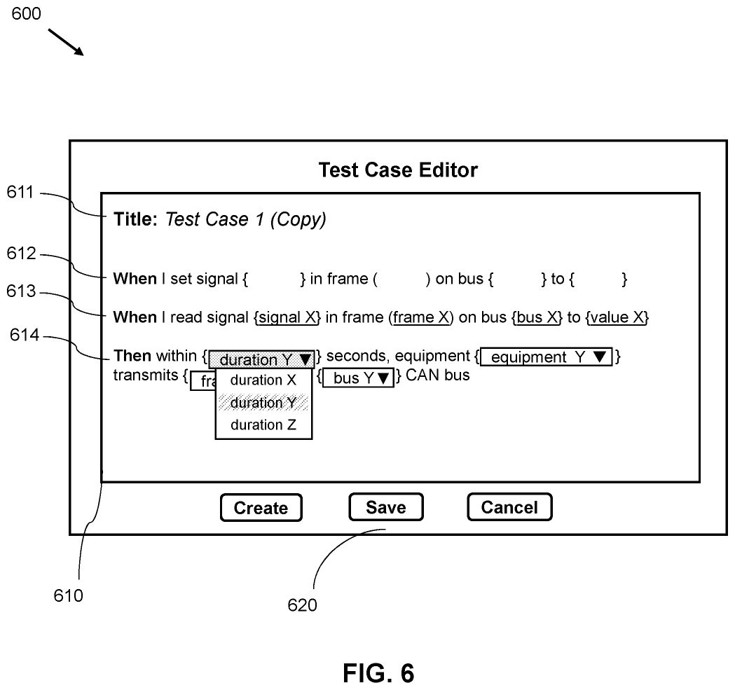

Alternatively or additionally, the user may create or build the new test case by utilizing one or more templates. For instance, the user may select (e.g., drag-and-drop, double click, etc.) one or more available test cases presented in the first portion 310 and/or the third portion 330, and/or may double click on the input window 320 and the at least one processor may generate additional interactive element (e.g., pop-out window, text input field, etc.) to allow the user to direct to the directory at which the desired template(s) is located so as to upload the template(s) therefrom. Accordingly, the user may utilize the template(s) to build or create the intended new test case(s). An example GUI which enables the user to utilize a test case template are described below with reference to FIG. 6.

It can be understood that the input window 320 may be configured to receive one or more first user inputs for defining a first portion of the intended test case(s) via descriptions, and to receive one or more second user inputs for defining a second portion of the intended test case(s) via utilizing the template(s). For instance, the user may define a first portion of test steps or test conditions via manually inputting the descriptions into the input window 321, and may define a second portion of the test steps or the test conditions via modifying a test case template.

Further, each of the plurality of interactive elements 322 may, when being interacted by the user, trigger an execution of one or more associated actions or operations. For instance, in the example of FIG. 3, the “Cancel” button may, upon being interacted by the user, trigger the at least one processor to terminate the on-going operations (e.g., closing the GUI 300, redirecting the user to a page prior to GUI 300, signing out the user from the test case management system, etc.). Further, the “Save” button may, upon being interacted by the user, trigger the at least one processor to create a project file (or any other suitable file or document) including the current progress, configuration, or the like, that the user has provided into the input window 321, the first portion 310, and/or the third portion 330. Furthermore, the “Create” button may, upon being interacted by the user, trigger the at least one processor to create a test case file including the descriptions or configurations provided by the user in the input window 321 for specifying the one or more new test cases. According to embodiments, upon creating the test case file, the at least one processor may store the created test case file to the one or more storage mediums, to thereby publish the created test case to selected users (features associated with sharing of the test case are further described below with reference to FIG. 4).

The third portion 330 may include components and information associated with test case(s) available to the user. As illustrated in FIG. 3, in some implementations, the third portion 330 may include a first sub-portion 331 and a second sub-portion 332. The first sub-portion 331 may include a search field (or any other suitable interactive element) which enables the user to input one or more criteria (e.g., keyword, etc.) defining one or more test cases of interest. In the example of FIG. 3, the user has inputted into the first sub-portion 331 the keywords of “ECU A” and “Validation”, indicating that the user is interested to view available test cases which are associated with validation tests that involve ECU A. Accordingly, the at least one processor may obtain, from a plurality of nodes communicatively coupled to the test case management system (e.g., nodes 130-1 to 130-N in FIG. 1, etc.), information of test cases associated with ECU A and/or validation test, and may update the second sub-portion 332 to present the obtained information.

In some implementations, in addition to the one or more user-inputted criteria, the at least one processor may also take the user information into consideration when searching for the available test cases. For instance, in the example of FIG. 3, upon obtaining information of test cases associated with ECU A and/or validation test, the at least one processor may determine which of the test cases are associated with the role or persona of the user, which of the test cases are authorized to be presented to the user, which of the test cases are related with the project(s) associated with the user, and the like, and may then present only the determined test cases to the user.

The second sub-portion 332 may include components and information associated with the available test cases of the user interest. For instance, as illustrated in FIG. 3, the second sub-portion 3321 includes a plurality of selectable texts associated with the criteria (e.g., “ECU A” and “Validation”) provided by the user in the first sub-portion 332. The selectable texts in the second sub-portion may, for example, each associated with a respective category of test cases and may contain one or more sub-portions when being interacted (e.g., selected, clicked, tapped, etc.) by the user. In some implementations, one or more of the plurality of sub-portions may further contain one or more sub-portions. For instance, in the example of FIG. 3, a plurality of test cases associated with validation test involving ECU A has been found by the at least one processor, while the selectable texts associated with “Validation Test 1” is first being selected by the user. Thus, the at least one processor may update the second sub-portion 332 to display the selectable texts associated with available test cases associated with “Validation Test 1”.

According to embodiments, one or more of the test cases presented in the second sub-portion 332 may be interactable by the user in specifying or creating one or more new test cases. For instance, the user may drag-and-drop one or more portions of the test case(s), such as a whole content of the test case(s), a step(s) of the test case(s), or the like, presented in the second sub-portion 332 to the input window 321 of the second portion 320 when creating the one or more new test cases. In addition, the user may build or create the new test case(s) in the second portion 320 while referencing to one or more available test cases presented in the third portion 330. For instance, upon determining one or more user interactions with a selectable text in the second sub-portion 332, the at least one processor may present (in an additional GUI, in an additional portion of GUI 300, etc.) the content of the test case associated with the interacted selectable text, such that the user may view the content of the selected test case therefrom. It can be understood that one or more of the test cases presented in the first portion 310 may be interactable by the user in specifying or creating one or more new test case in a similar manner.

Furthermore, the user may add one or more of the test cases presented in the second sub-portion 332 to the list 311 in the first portion 310, such that the user may easily access the test case(s) in the future. For instance, the user may drag-and-drop the selectable text(s) associated with the intended test case(s) to the first portion 310, and the at least one processor may update the first portion 310 to include the test case(s) associated with said selectable text(s).

In view of the above, example embodiments of the present disclosure provides a test case management system which generates and presents one or more GUIs that allow one or more users to easily and efficiently view, search, and create one or more test cases.

Referring next to FIG. 4, which illustrates an example GUI 400, according to one or more embodiments. GUI 400 may be generated by the at least one processor (e.g., processor 230) of the test case management system and may be presented by the at least one processor to a user to allow the user to view and to configure test case(s) associated with the user. For instance, in the example of FIG. 4, GUI 400 may be generated and presented to the user after the user has created a new test case via utilizing the GUI 300 of FIG. 3.

The GUI 400 may include a first portion 410, a second portion 420, and a third portion 430. The first portion 410 may include a list of test cases associated with the user and one or more interactive elements associated with operation(s) for managing the list, in a similar manner as described above with reference to the first portion 310 of GUI 300. Thus, redundant descriptions associated therewith may be omitted below for conciseness.

The second portion 420 may include a browsing window 421 configured to present information of a test case selected by the user in the first portion 410, and may include a plurality of interactive elements 422 to allow the user to manage the selected test case. For instance, in the example of FIG. 4, the user has interacted with the selectable text associated with “Test Case 1” in the first portion 410, and thus the at least one processor may obtain information associated with the selected test case and may update the browsing window 421 to present the content of the selected test case. According to embodiments in which the user has selected a portion of a test case (e.g., one or more test steps, etc.), the at least one processor may update the browsing window 421 to present only the selected portion of the test case.

Further, each of the plurality of interactive elements 422 may, when being interacted by the user, trigger an execution of one or more associated actions or operations. For instance, in the example of FIG. 4, the “Cancel” button may, upon being interacted by the user, trigger the at least one processor to terminate the on-going operations (e.g., closing the GUI 400, redirecting the user to a page prior to GUI 400, clearing the content presented in the browsing window 421, etc.). Further, the “Edit” button may, upon being interacted by the user, trigger the at least one processor to update the third portion 430 to include information and elements for enabling the user to edit the selected test case. Furthermore, the “Temp.” button may, upon being interacted by the user, trigger the at least one processor to update the GUI 400 to, or may generate an additional GUI which may, include information and elements for enabling the user to define or create one or more new test cases while utilizing the selected test case as a template (an example GUI which includes said information and elements are described below with reference to FIG. 6).

The third portion 430 may include a plurality of interactive elements which enable the user to modify or edit the test case selected by the user in the first portion 410 or in the second portion 420. In the example of FIG. 4, the third portion 430 includes a plurality of interactive elements 432 which are associated with operations for modifying the configurations for sharing the selected test case (“Test Case 1”). Specifically, the plurality of interactive elements 432 includes a plurality of tick boxes, each of which is associated with a user group to which the user can share the selected test case. The user may select one or more of the user groups presented in the third portion 430 by clicking or checking the associated text boxes, and the at least one processor may determine which of the plurality of text boxes have been interacted by the user, may determine the user group associated therewith, and may update the sharing configuration of the selected test case such that the selected test case is visible and accessible by the user-selected user group(s).

Further, the plurality of interactive elements 432 also includes a plurality of buttons, each of which may, when being interacted by the user, trigger an execution of one or more associated actions or operations. For instance, in the example of FIG. 4, the “Save” button may, upon being interacted by the user, trigger the at least one processor to collect information of the user-selected tick box(s), to determine the user-group associated with the user-selected tick box(s), and to update the sharing configuration of the selected test case based thereon. Further, the “Edit” button may, upon being interacted by the user, trigger the at least one processor to generate and present one or more additional GUIs which include information and elements which enable the user to edit the plurality of text boxes (e.g., adding a new text box and associated new user group, deleting an existing text box and the associated user group, arranging the order of the existing text boxes and the associated user groups, etc.) and/or to edit the available user groups (e.g., renaming the user groups, setting one or more user groups as default, etc.). Furthermore, the “Default” button may, upon being interacted by the user, trigger the at least one processor to restore the sharing configuration of the selected test case to default configuration.

In view of the above, example embodiments of the present disclosure provides a test case management system which generates and presents one or more GUIs that allow one or more users to easily and efficiently view, utilize, and configure one or more associated test cases.

It can be understood that, although the GUI 300 and GUI 400 are described and illustrated herein as separated GUIs, the user may configure the GUI(s) to include the information and/or elements of interest in any suitable manner. For instance, the user may configure the GUI 300 to include a test case browser (e.g., the second portion 420 of GUI 400), may configure the GUI 400 to include a test case library (e.g., the third portion 330 of GUI 300), and the like.

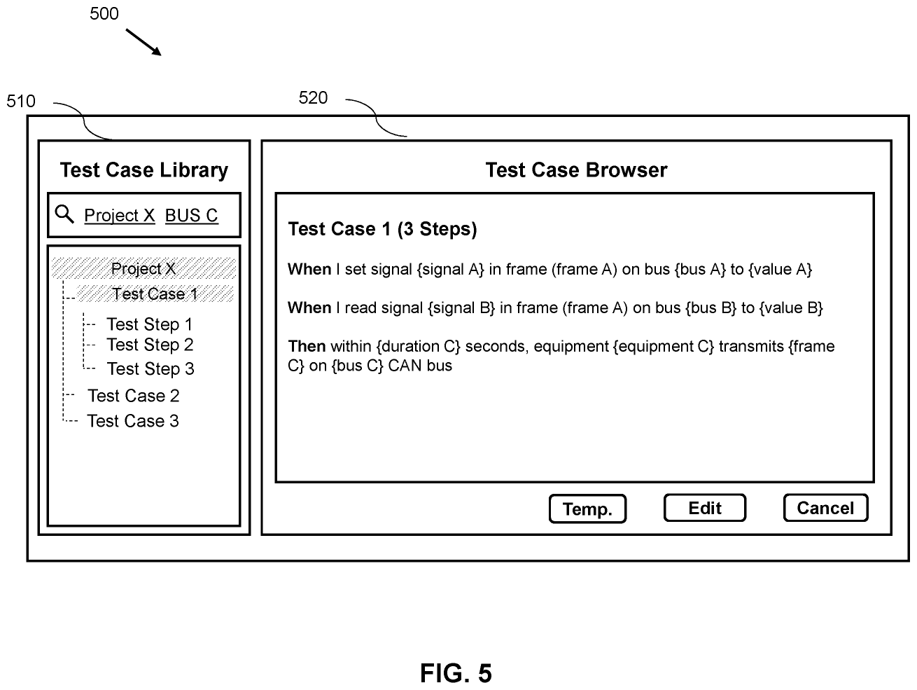

For instance, referring to FIG. 5, which illustrates an example GUI 500, according to one or more embodiments. GUI 500 may be generated by the at least one processor (e.g., processor 230) of the test case management system based on a user-defined configuration. For instance, in the example of FIG. 5, the GUI 500 includes a first portion 510 which is similar to the third portion 330 of GUI 300, and a second portion 520 which is similar to the second portion 420 of GUI 400. Thus, redundant descriptions associated therewith may be omitted below for conciseness.

In view of the above, example embodiments of the present disclosure provides a test case management system which enable one or more users to freely customize how specifically the one or more GUIs should be presented, such that said one or more users may utilize the test case management system in their intended manner to thereby easily and efficiently manage one or more test cases.

Referring next to FIG. 6, which illustrates an example GUI 600, according to one or more embodiments. GUI 600 may be generated by the at least one processor (e.g., processor 230) of the test case management system and may be presented by the at least one processor to a user to allow the user to utilize an available test case (e.g., test case previously built by the user or by another user, etc.) as a template in creating and defining a new test case. For instance, in the example of FIG. 6, GUI 600 may be generated and presented to the user by the at least one processor based on determining a user interaction with the “Temp.” button in the second portion 420 of GUI 400 or the second portion 520 of GUI 500, and the like.

As illustrated in FIG. 6, the GUI 600 may include an input window 610 and a plurality of interactive elements 620. The role and functions of the plurality of interactive elements 620 may be similar to the plurality of interactive elements 322 in GUI 300 (described above with reference to FIG. 3), thus redundant descriptions associated therewith may be omitted below for conciseness.

The input window 610 may include the contents of the test case selected as the template, while said contents may be presented in one or more editable formats such that the user may simply modify one or more intended content according to intended manner. For instance, in the example of FIG. 6, the title of the selected test case and each of the test steps included in the selected test case are presented in a plurality of editable formats.

Specifically, the editable texts 611 may be associated with the title of the new test case to-be built based on the template of the selected test case, and said editable texts 611 may, upon being interacted by the user, trigger the at least one processor to receive one or more user inputs for defining or renaming the title of the to-be built new test case. According to embodiments, the at least one processor may generate the editable texts 611 based on a default configuration (configured by the user, etc.), For instance, in the example of FIG. 6, the at least one processor may generate the GUI 600 such that the first portion 610 include a default title according to a default naming configuration of placing the terms “(Copy)” behind the original title of the selected test case.

Further, the editable texts 612 may be associated with a first test step of the selected test case, and said editable texts 612 may include a plurality of input fields (illustrated as “{ }” in FIG. 6) each of which may, upon being interacted by the user, trigger the at least one processor to receive one or more user inputs for defining one or more parameters of the first test step. The one or more parameters may include a parameter defining a software-based component (e.g., name of a virtual ECU, name of a signal frame, etc.), a parameter defining a hardware-based component (e.g., name of a physical bus, etc.), a parameter defining a time duration (e.g., a value in seconds, minutes, etc.), a parameter defining test environment fidelity (e.g., hardware resources, simulated resources, emulated resources, etc.), and/or any other suitable parameter which, when combining with the descriptions of the test step, form one or more test conditions of the test case.

According to embodiments, at least a portion of the plurality of input fields of the editable texts may be pre-filled or be pre-populated by the at least one processor. Specifically, the plurality of input fields of the editable texts 613 may be pre-filled or be pre-populated by the at least one processor based on, for example, user information of one or more users. For instance, the at least one processor may determine, based on usage history of a plurality of users, which parameters are the most popular in defining the same (or similar) test step, and may then automatically filled in the plurality of input fields accordingly when generating the GUI 600. As another example, the at least one processor may determine, based on usage history of the user, which parameters are mostly used in defining and creating new test cases, and may then automatically filled in the plurality of input fields accordingly when generating the GUI 600.

According to embodiments, the at least one processor may present one or more selectable options of parameter in at least a portion of the plurality of input fields of the editable texts. Specifically, the at least one processor may determine the type of parameter associated with the respective input field, may collect the information of possible parameters from among the plurality of nodes (e.g., nodes 130-1 to 130-N), and may present the possible parameters in the associated input field for user selection. For example, when generating the GUI 600, the at least one processor may determine that the first input field of the editable texts 614 is associated with a parameter defining time duration, may collect from the plurality of nodes information of the available resources and/or possible configuration of available test environments, may determine possible parameter for defining the time duration, and may then include the possible parameters into the first input field in the form of a drop-down list.

It can be understood that, the input fields associated with each of the test steps of the selected test case are described and illustrated differently herein merely for descriptive purpose. In practice, all of the input fields of all test steps may be the same (e.g., all input fields are automatically pre-populated, etc.), or the like, without departing from the scope of the present disclosure.

In view of the above, example embodiments of the present disclosure provides a test case management system which enable one or more users to utilize one or more available test cases, such as one or more test cases built by and shared by other users, one or more test cases built by the one or more users, and/or the like, such that said one or more users may use said one or more available test cases as a template(s) for creating one or more new test cases.

It can be understood that the GUIs described hereinabove with references to FIG. 3 to FIG. 6 are merely examples of possible embodiments, and the scope of the present disclosure should not be limited thereto. Specifically, one or more of said GUIs may include more or less information or components than as illustrated, and/or may be arranged in a manner different from as illustrated. For instance, the GUI 300 may include a fourth portion to allow the user(s) to configure the sharing configuration of one or more test cases, in a similar manner as described above with reference to the third portion 430 of GUI 400, the GUI 500 may include an additional portion for illustrating a list of test cases associated with the user, in a similar manner as described above with reference to the first portion 310 of GUI 300, and the like, without departing from the scope of the present disclosure.

In view of the above, the at least one processor of the test case management system may be configured to generate appropriate GUIs and to present the same to the user(s), and the user(s) may easily, efficiently manage one or more test cases via interacting with the presented GUIs.

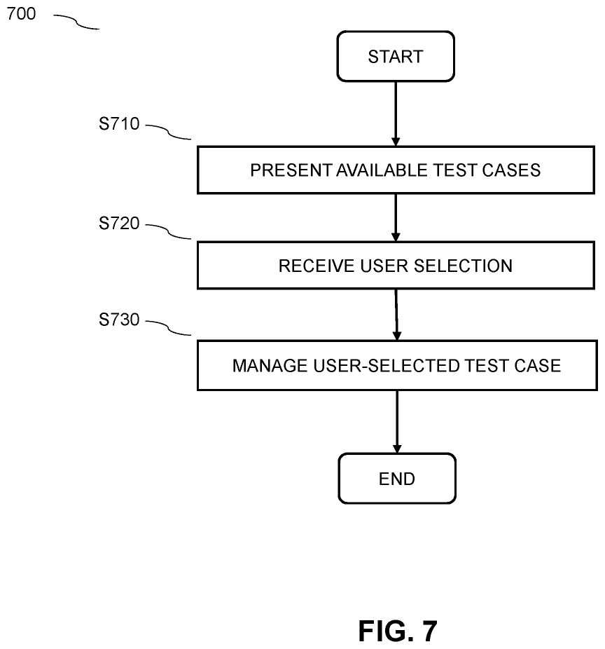

Next, the operations performable by the at least one processor (e.g., processor 230) of the test case management system are described with reference to FIG. 7. Referring to FIG. 7, which illustrates a flow diagram of an example method 700 for managing one or more test cases of a test for testing a software associated with a vehicle system, according to one or more embodiments. One or more operations of method 700 may be performed by the at least one processor, upon executing computer-executable instructions stored in at least one memory storage (e.g., storage 220). The software being tested may include an in-vehicle electronic control unit (ECU), and/or any other software associated with the vehicle system.

As illustrated in FIG. 7, at operation S710, the at least one processor may be configured to present information associated with one or more test cases available to a user (may be referred to as “one or more available test cases” herein). Specifically, the at least one processor may present, to the user, a first GUI comprises information of the one or more available test cases.

The first GUI may include one or more information or components of one or more of GUI 300 to GUI 600 (described above with reference to FIG. 3 to FIG. 6, respectively). For instance, the first GUI may include the first portion 310 and/or the third portion 330 of the GUI 300, may include the first portion 410 of the GUI 400, may include the first portion 510 of the GUI 500, and/or the like.

According to embodiments, the at least one processor may obtain from one or more storage mediums (e.g., storage 220, server(s) external to the test case management system, etc.) information associated with the user (may be referred to as “user information” herein), may determine the one or more available test cases based on the obtained user information, may generate the first GUI to include the information associated with the one or more available test cases, and may transmit the first GUI to at least one user equipment (e.g., UE 120-1 to 120-N, etc.) associated with the user, to thereby present the first GUI to the user. The user information may include, for example, a role of the user (e.g., test engineer, software developer, etc.), a project associated with the user (e.g., a project assigned to the user, a project managed by the user, etc.), a workgroup associated with the user (e.g., a team of users with which the user is collaborating, etc.), and a location associated with the user (e.g., a current location, a last known location, a planned location, etc.).

Subsequently, at operation S720, the at least one processor may be configured to receive, from the user, a user input defining a user selection of a test case from among the one or more available test cases (may be referred to as “user-selected test case” herein). For instance, the first GUI comprises one or more interactive elements (e.g., selectable texts, etc.) each of which is associated with an available test case from among the one or more available test case (refer to, for example, descriptions associated with the selectable texts in the first portion 310 and the third portion 330 of the GUI 300). In this regard, the at least one processor may be configured to receive the user input by: receiving a user interaction with at least one interactive element from among the one or more interactive elements; and determining the available test case associated with the user-interacted at least one interactive element as the user-selected test case.

Further, at operation S730, the at least one processor may be configured to perform one or more operations for managing the user-selected test case. For instance, the at least one processor may present, to the user, a second GUI comprises information associated with the user-selected test case. The second GUI may include one or more information or components of one or more of GUI 300 to GUI 600 (described above with reference to FIG. 3 to FIG. 6, respectively). For instance, the second GUI may include the third portion 330 of the GUI 300, may include the second portion 420 of the GUI 400, may include the second portion 520 of the GUI 500, may include the input window 610 of the GUI 600, and/or the like. Through the second GUI, the user may utilize the selected test case as a template for creating a new test case.

For instance, the at least one processor may receive, from the user, one or more user inputs for modifying at least a portion of the information associated with the user-selected test case. Subsequently, the at least one processor may generate, based on the user input, a new test case which comprises at least a portion of information different from the user-selected test case.

By way of example, the information associated with the user-selected test case may include a title, a labelling, or a descriptions associated with the user-selected test case, and the at least one processor may receive, via the second GUI, one or more user inputs for modifying the title, the labelling, and/or the descriptions of the user-selected test case (refer to, for example, descriptions associated with the editable texts 611 provided above with reference to FIG. 6). Accordingly, the at least one processor may generate a new test case with the modified title, labelling, and/or descriptions.

As another example, the information associated with the user-selected test case may include one or more test steps associated with the user-selected test case, and the second GUI comprises at least one input field associated with the one or more test steps (referring to, for example, descriptions associated with the input fields of the editable texts 612 to 614 provided above with reference to FIG. 6).

In this regard, the at least one processor may be configured to receive the user input via the second GUI by receiving a user selection on at least one parameter for defining the test step, and may be configured to generate the new test case by generating the new test case based on the user-defined test step. As described above with reference to FIG. 6, the at least one parameter may include at least one of: a parameter defining a software-based component (e.g., a software-based ECU, etc.), a parameter defining a hardware-based component (e.g., a hardware-based ECU, etc.), a parameter defining a time duration (e.g., a value in seconds, minutes, etc.), a parameter defining test environment fidelity (e.g., hardware resources, simulated resources, emulated resources, etc.), and/or any other suitable parameters.

Specifically, the at least one processor may receive, from the user, one or more user inputs (e.g., one or more keywords associated with the at least one parameter) in the at the least one input field. Additionally or alternatively, the at least one input field may include a parameter pre-filled by the at least one processor. In that case, the at least one processor may receive, from the user, an approval on the pre-filled parameter (e.g., a user interaction with an associated interactive element, etc.), or a modification on the pre-filled parameter (e.g., revise the pre-filled parameter, etc.). Additionally or alternatively, the at least one input field may include a plurality of selectable parameters (e.g., in the form of a drop-down list, etc.). In that case, the at least one processor may receive, from the user, at least one user selection on at least one parameter from among the plurality of selectable parameters.

To this end, example embodiments of the present disclosure provide a test case management system (and a method for utilizing the same) which enable one or more users to effectively and efficiently manage one or more test cases, which in turn addresses the problems in the related art as described above.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method for managing one or more test cases of a test for testing a software associated with a vehicle system, the method is implemented by at least one processor and comprising:
presenting, to a user, a first graphical user interface (GUI) comprises information of one or more test cases available to the user;
receiving, from the user, a user input defining a user selection of a test case from among the one or more available test cases; and
performing at least one operation for managing the user-selected test case.

2. The method according to claim 1, wherein the presenting the first GUI comprises:
obtaining, from at least one storage medium, information associated with the user;
determining, based on the obtained user information, the one or more available test cases;
generating the first GUI to include information associated with the one or more available test cases; and
transmitting the first GUI to a user equipment associated with the user.

3. The method according to claim 1, wherein the first GUI comprises one or more interactive elements each of which is associated with an available test case from among the one or more available test case, and wherein the receiving the user input comprises:
receiving a user interaction with at least one interactive element from among the one or more interactive elements; and
determining the available test case associated with the user-interacted at least one interactive element as the user-selected test case.

4. The method according to claim 1, wherein the performing the at least one operation comprises:
presenting, to the user, a second GUI comprises information associated with the user-selected test case;
receiving, from the user, a user input for modifying at least a portion of the information associated with the user-selected test case; and
generating, based on the user input, a new test case, wherein the new test case comprises at least a portion of information different from the user-selected test case.

5. The method according to claim 2, wherein the obtained user information comprises at least one of: a role of the user, a project associated with the user, a workgroup associated with the user, and a location associated with the user.

6. The method according to claim 4, wherein:
the information associated with the user-selected test case comprises: at least one test step associated with the user-selected test case;
the second GUI comprises at least one input field associated with the at least one test step;
the receiving the user input comprises: receiving a user selection on at least one parameter for defining the at least one test step; and
the generating the new test case comprises: generating the new test case based on the user-defined at least one test step.

7. The method according to claim 6, wherein the receiving the user selection on the at least one parameter comprises:
receiving, from the user, one or more user inputs in the at least one input field, wherein the one or more user inputs comprises one or more keywords associated with the at least one parameter.

8. The method according to claim 6, wherein the at least one input field comprises a pre-filled parameter, and the receiving the user selection on the at least one parameter comprises:
receiving, from the user, an approval on the pre-filled parameter or a modification on the pre-filled parameter.

9. The method according to claim 6, wherein the at least one input field comprises a plurality of selectable parameters, and the receiving the user selection on the at least one parameter comprises:
receiving, from the user, at least one user selection on at least one parameter from among the plurality of selectable parameters.

10. The method according to claim 6, wherein the at least one parameter comprises at least one of: a parameter defining a software-based ECU, a parameter defining a hardware-based ECU, and a parameter defining test environment fidelity.

11. A system for managing one or more test cases of a test for testing a software associated with a vehicle system, the system comprises:
a memory storage storing instructions; and
at least one processor configured to execute the instructions to:
present, to a user, a first graphical user interface (GUI) comprises information of one or more test cases available to the user;
receive, from the user, a user input defining a user selection of a test case from among the one or more available test cases; and
perform at least one operation for managing the user-selected test case.

12. The system according to claim 11, wherein the at least one processor configured to execute the instructions to present the first GUI by:
obtaining, from at least one storage medium, information associated with the user;
determining, based on the obtained user information, the one or more available test cases;
generating the first GUI to include information associated with the one or more available test cases; and
transmitting the first GUI to a user equipment associated with the user.

13. The system according to claim 1, wherein first GUI comprises one or more interactive elements each of which is associated with an available test case from among the one or more available test case, and wherein the at least one processor configured to execute the instructions to receive the user input by:
receiving a user interaction with at least one interactive element from among the one or more interactive elements; and
determining the available test case associated with the user-interacted at least one interactive element as the user-selected test case.

14. The system according to claim 1, wherein the at least one processor configured to execute the instructions to perform the at least one operation by:
presenting, to the user, a second GUI comprises information associated with the user-selected test case;
receiving, from the user, a user input for modifying at least a portion of the information associated with the user-selected test case; and
generating, based on the user input, a new test case, wherein the new test case comprises at least a portion of information different from the user-selected test case.

15. The system according to claim 12, wherein the obtained user information comprises at least one of: a role of the user, a project associated with the user, a workgroup associated with the user, and a location associated with the user.

16. The system according to claim 14, wherein:
the information associated with the user-selected test case comprises: at least one test step associated with the user-selected test case;
the second GUI comprises at least one input field associated with the at least one test step;
the at least one processor configured to execute the instructions to receive the user input by: receiving a user selection on at least one parameter for defining the at least one test step; and
the at least one processor configured to execute the instructions to generate the new test case by: generating the new test case based on the user-defined at least one test step

17. The system according to claim 16, the at least one processor configured to execute the instructions to receive the user selection on the at least one parameter by:
receiving, from the user, one or more user inputs in the at least one input field, wherein the one or more user inputs comprises one or more keywords associated with the at least one parameter.

18. The system according to claim 16, wherein the at least one input field comprises a pre-filled parameter, and the at least one processor configured to execute the instructions to receive the user selection on the at least one parameter by:
receiving, from the user, an approval on the pre-filled parameter or a modification on the pre-filled parameter.

19. The system according to claim 16, wherein the at least one input field comprises a plurality of selectable parameters, and the at least one processor configured to execute the instructions to receive the user selection on the at least one parameter by:
receiving, from the user, at least one user selection on at least one parameter from among the plurality of selectable parameters.

20. The system according to claim 16, wherein the at least one parameter comprises at least one of: a parameter defining a software-based ECU, a parameter defining a hardware-based ECU, and a parameter defining test environment fidelity.
